(19) United States
(12) Patent Application Publication
(10) Pub. No.: US 2008/0186618 A1
(43) Pub. Date: Aug. 7, 2008

(54) Architecture for write pre-compensation

(75) Inventor: Koon Lun Wong, Irvine, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/803,098

(22) Filed: May 11, 2007

Related U.S. Application Data
(60) Provisional application No. 60/899,540, filed on Feb. 5, 2007.

(51) Int. Cl. G11B 5/596

(52) U.S. Cl. 360/77.04

(57) ABSTRACT

An architecture to compensate for the non-linear effects of magnetic media, such as magnetic disk drives, that distorts data transitions when data is written to the media and in which the non-linear distortion is data sequence dependent. In one technique a circuit is used to alter the data transitions to cancel the effects of the transition distortion. The circuit employs selected delays that that based on the data sequence to adjust the transition edge of bits of the data to provide the pre-compensation before data is written to the disk.

### CROSS REFERENCE TO RELATED APPLICATION

This application claims the benefit of priority to U.S. Provisional Patent Application Ser. No. 60/899,540; filed Feb. 5, 2007; and titled “Architecture for write pre-compensation,” which is incorporated herein by reference.

### BACKGROUND OF THE INVENTION

1. Technical Field of the Invention

The embodiments of the invention relate generally to disk drives and, more particularly, to providing compensation prior to writing data to a disk.

2. Description of Related Art

Varieties of memory storage devices, such as magnetic disk drives, are available to store data and are used to provide data storage for a host device, either directly, or through a network. Those networks may be a storage area network (SAN) or a network attached storage (NAS). Typical host devices include stand alone computer systems such as a desktop or laptop computer, enterprise storage devices such as servers, storage arrays such as a redundant array of independent disk (RAID) arrays, storage routers, storage switches and storage directors, and other consumer devices such as video game systems and digital video recorders. These devices generally provide high storage capacity in a cost effective manner.

One class of disk storage devices uses magnetic media to store information. In order to ensure that digital data is written to the disk and retrieved correctly, it is desirable to have defect-free media and a controller that is capable of correctly writing and reading back the stored data. However, since data is stored on the magnetic medium as magnetically aligned signals and this data is read back by the magnetoresistive head as an analog signal, a number of conditions are encountered that may corrupt the recovery of the original data. For example, various jitter (e.g. timing jitter, data dependent jitter, transition jitter, etc.) may be introduced in the operation of the disk drive. Further, the non-linearity of the magnetoresistive head may introduce noise or distortions in the data signal. Because the bit cell boundary separating the bits on the sector (or track) of the disk is not an ideal straight edge, magnetic boundaries may not be sharply delineated to provide a substantially constant amplitude signal when read by the head. Some or all of these conditions may be encountered, which may potentially cause an unwanted bit-error rate (BER) with the recovered data.

Additionally, distortion may be introduced during the write phase when data is written to the disk. For example, non-linear transition shifts (NLTS) may occur, due to the nature of the magnetic field alignment on the magnetic material when data is written. NLTS is data dependent and the location of the bit cell boundaries vary depending on the bit sequence being written to the disk. NLTS complicates the data read back procedure, since the read channel of a disk drive may need to address the amplitude variations introduced in the read signal, in which the amplitude variations is dependent on the bit sequence stored. NLTS alone may not cause an undesirable BER condition (although it could), but it may have a cumulative effect on various other conditions that introduce unwanted conditions, such as jitter, noise, etc.

Accordingly, if there is a technique to remove distortion effects (such as NLTS) during data writing to ensure that a substantially consistent magnetic transition is encountered that is not bit sequence dependent, at least one component of error causing effect may be reduced or removed. One technique to reduce transition distortion is to provide a form of write pre-compensation when writing data to a disk.

### SUMMARY OF THE INVENTION

The present invention is directed to apparatus and methods of operation that are further described in the following Brief Description of the Drawings, the Detailed Description of the Embodiments of the Invention, and the Claims. Other features and advantages of the present invention will become apparent from the following detailed description of the embodiments of the invention made with reference to the accompanying drawings.

### BRIEF DESCRIPTION OF THE SEVERAL VIEWS OF THE DRAWINGS

FIG. 1 shows an embodiment of a disk drive device for practicing the invention.

FIG. 2 shows one embodiment of an apparatus that has a disk controller that implements the invention.

FIG. 3 shows one example of storing bits on a magnetic medium when non-linear transition shift occurs based on a bit sequence being stored.

FIG. 4 shows one embodiment of the invention using multiple delays to provided pre-compensation when writing data to a disk.

FIG. 5A shows one embodiment of a circuit to implement write pre-compensation of FIG. 4.

FIG. 5B shows a timing diagram for the signals pertaining to the circuit of FIG. 5A.

FIG. 6A shows another embodiment of a circuit to implement write pre-compensation of FIG. 4.

FIG. 6B shows a timing diagram for the signals pertaining to the circuit of FIG. 6A.

FIG. 7 shows another embodiment of a more detailed circuit to implement the write pre-compensation technique of FIG. 4.

FIG. 8A shows a circuit schematic diagram of an embodiment of a phase interpolator used to generate delays.

FIG. 8B shows a graphical representation on how the phase variations are obtained for the circuit of FIG. 8A.

FIG. 9 shows a circuit schematic diagram of another embodiment of a phase interpolator that uses eight stages to generate 8 delays.

### DETAILED DESCRIPTION OF THE EMBODIMENTS OF THE INVENTION

The embodiments of the present invention may be practiced in a variety of settings that implement a disk drive, such as a hard disk drive (HDD), or other data storage devices. Although the technique described below pertains to pre-compensating data written to a magnetic medium of a disk drive, it need not be limited strictly to such use. The write pre-compensation technique described may be applied to a variety of systematic transition variations, in which transition edges and boundaries may be compensated. Furthermore, the example embodiments described below use a particular circuit to achieve the pre-compensation, but other embodiments may use other circuits and/or techniques that are operable alternatives to the specific described technique.

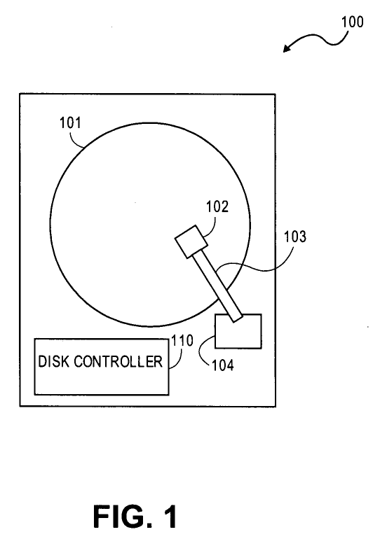

FIG. 1 illustrates an example embodiment of a disk drive 100 for practicing an embodiment of the invention. In particular, disk drive 100 is a HDD device that includes a disk 101 to store data. Disk 101 is typically rotated by a servo motor (not shown) at a specified velocity depending on a particular application for its use. Disk 101 may be constructed from various materials and in one embodiment disk 101 is a magnetic disk that stores information as magnetic field changes on some type of magnetic medium. The medium may be rigid or non-rigid, although HDD devices generally have rigid disks. Disk 101 may be removable or non-removable. Disk 101 typically is made of magnetic material or coated with magnetic material. It is to be noted that in other embodiments, disk 101 may employ other data storage technology, such as an optical medium, and need not be limited to magnetic storage.

Disk drive 100 typically includes one or more read/write heads 102 that are coupled to an arm 103 that is moved by an actuator 104 over the surface of the disk 101 either by translation, rotation or both. Disk drive 100 may have one disk 101, or multiple disks with multiple read/write heads 102. Disk drive 100 includes a disk controller module 110 that is utilized for controlling the operation of the disk drive, including read and write operations to disk 102, as well as controlling the speed of the servo or motor and the motion of actuator 104. Disk controller module 110 may also include an interface to couple to an external device, such as a host device. It is to be noted that disk drive 100 is but one example and other disk drives may be readily implemented to practice various embodiments of the invention.

Disk drive 100, or any other equivalent disk drive, may be implemented in a variety of devices. For example, disk drive 100 may be implemented in a handheld unit, such as a handheld audio unit. In one such embodiment, disk drive 100 may include a small form factor magnetic disk and incorporated into or otherwise used by handheld audio unit to provide general storage, including storage of audio content.

In another example embodiment, disk drive 100 may be implemented in a computer. In one such embodiment, disk drive 100 may include a magnetic disk for various applications, including enterprise storage applications. Disk drive 100 may be incorporated into or otherwise used by a computer to provide general purpose storage and the computer may be attached to a storage array, such as a redundant array of independent disks (RAID) array, storage router, edge router, storage switch and/or storage director. Disk drive 100 may be implemented in a variety of computers (or computing devices), such as desktop computers and notebook computers.

In another example embodiment, disk drive unit 100 may be implemented in a wireless communication device to provide general storage. In one such embodiment, the wireless communication device may communicate via a wireless telephone network such as a cellular, personal communications service (PCS), general packet radio service (GPRS), global system for mobile communications (GSM), integrated digital enhanced network (iDEN) or other wireless communications network capable of sending and receiving telephone calls. Furthermore, the wireless communication device may communicate via the Internet to access email, download content, access websites, and provide streaming audio and/or video programming. In this fashion, the wireless communication device may place and receive telephone calls, text messages, short message service (SMS) messages, pages and other data messages that may include attachments such as documents, audio files, video files, images and other graphics.

Still as another example, disk drive 100 may be implemented in the personal digital assistant (PDA). In one such embodiment, disk drive 100 may include a small form factor magnetic hard disk to provide general data storage. Still in another embodiment, disk drive 100 may be implemented in a television set (such as a high-definition television) or a digital video recorder to store video information.

In these various embodiments for disk drive 100, a variety of data, as well as program instructions, may be stored. Stored data may include, and is not limited to, general data, data for motion picture expert group (MPEG) audio layer 3 (MP3) files or Windows Media Architecture (WMA) files, video content such as MPEG4 files, JPEG (Joint Photographic Expert Group) files, bitmap files and files stored in other graphics formats, emails, webpage information and other information downloaded from the Internet, address book information, and/or any other type of information that may be stored on a disk medium.

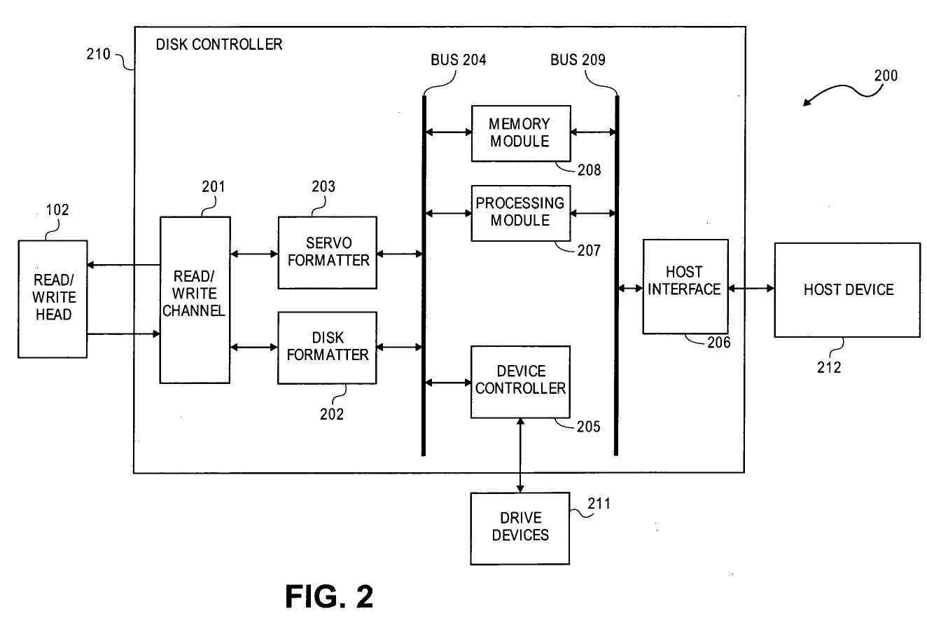

FIG. 2 illustrates an embodiment of an apparatus 200 that may be implemented with disk drive 100 of FIG. 1. Read/write head 102 is shown coupled to a disk controller 210, which may be used for disk controller 110 of FIG. 1. In the particular embodiment, disk controller 210 includes a read/write channel 201 coupled to head 102 for reading and writing data to and from disk 101. A disk formatter 202 is included for controlling the formatting of data and provides clock signals and other timing signals that control the flow of the data written to and data read from disk 101 through read/write channel 201. A servo formatter 203, also coupled to read/write channel 201, provides clock signals and other control and timing signals based on servo control data read from disk 101. Disk formatter 202 and servo formatter 203 are also coupled to bus 204. Disk controller 210 further includes a device controller 205, host interface 206, processing module 207 and memory module 208, as well as a second bus 209. Device controller 205 controls the operation of one or more drive device(s) 211. Device(s) 211 may be one or more device(s) such as actuator 104 and the servo (or spindle) motor used to rotate disk 101. Host interface 206 is coupled between bus 209 and a host device 212 to receive commands from host device 212 and/or transfer data between host device 212 and disk 101 in accordance with a particular protocol.

Processing module 207 may be implemented using one or more microprocessors, micro-controllers, digital signal processors, microcomputers, central processing units, field programmable gate arrays, programmable logic devices, state machines, logic circuits, analog circuits, digital circuits, and/or any device that manipulates signal (analog and/or digital) based on operational instructions. The operational instructions may reside in memory module 208 or may reside elsewhere. When processing module 207 is implemented with two or more devices, each device may perform the same steps, processes or functions in order to provide fault tolerance or redundancy. Alternatively, the function, steps and processes performed by processing module 207 may be split between different devices to provide greater computational speed and/or efficiency.

Memory module 208 may be a single memory device or a plurality of memory devices. Such a memory device may be a read-only memory (ROM), random access memory (RAM), volatile memory, non-volatile memory, static random access memory (SRAM), dynamic random access memory (DRAM), flash memory, cache memory, and/or any device that stores digital information. It is to be noted that when processing module 207 implements one or more of its functions via a state machine, analog circuitry, digital circuitry, and/or logic circuitry, memory module 208 storing the corresponding operational instructions may be embedded within, or reside external to, the circuitry comprising the state machine, analog circuitry, digital circuitry, and/or logic circuitry. Furthermore, memory module 208 stores, and the processing module 207 executes, operational instructions that may correspond to one or more of the steps or a process, method and/or function described herein.

Each of these elements of controller 210 may be implemented in hardware, firmware, software or a combination thereof, in accordance with the broad scope of the present invention. While particular bus architecture is shown in FIG. 2 with buses 204, 209, alternative bus architectures that include either a single bus configuration or additional buses are likewise possible to be implemented as different embodiments.

In one embodiment, one or more modules of disk controller 210 are implemented as part of a system on a chip (SoC) integrated circuit. In the particular embodiment shown, disk controller 210 is part of a SoC integrated circuit that may include other circuits, devices, modules, units, etc., which provide various functions such as protocol conversion, code encoding and decoding, power supply, etc. In other embodiments, the various functions and features of disk controller 210 may be implemented in a plurality of integrated circuits that communicate and combine to perform the functionality of disk controller 210.

When the drive unit 100 is manufactured, disk formatter 203 generally writes a plurality of servo wedges along with a corresponding plurality of servo address marks at radial distance along the disk 101. The servo address marks are used by the timing generator for triggering a “start time” for various events employed when accessing the medium of the disk 101. Generally, these servo address marks are used to separate a particular track of the disk into a number of sectors for formatting the disk. Subsequently, user data is written to a selected sector of a given track on the disk to store the data. Generally, with magnetic media, a magnetoresistive head is used to write data onto the magnetic disk and read data from the disk. Read/write channel 201 sends data to be written to head 102 and, likewise, head 102 picks up the magnetic signal from the disk and conveys the signal to read/write head 201 to recover the data.

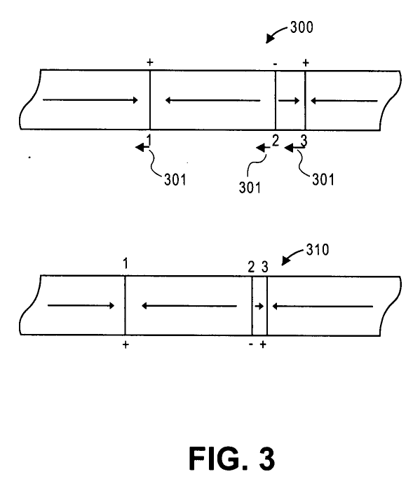

As noted in the Background section above, distortion may be introduced when writing data on to a disk. FIG. 3 shows one example of a non-linear transition shift (NLTS) when data is written onto a disk. A portion of a track of a disk is shown in upper diagram 300, in which magnetic fields are aligned horizontally. The direction of the magnetic field alignment corresponds to a bit state being stored. Diagram 300 illustrates three magnetic field transitions at transition boundaries 1, 2 and 3, that have corresponding polarities of “+”, “−” and “+” based on the shown magnetic alignment. Thus, transition boundaries 1-3 illustrate where the field alignments change and the shown polarity at each transition is dependent on whether the magnetic field arrows point toward a transition or away from it. Although the transitions are delineated by a sharp edge, in actual practice, the transitions are not so sharply defined.

In FIG. 3, diagram 300 shows an intended location for the transition boundaries 1-3 when the example data pattern is written. Prior art practice is to use a fixed bit period of a specified duration, since the data is typically latched through using a fixed clock. However, due to data dependent non-linearity in writing the data, transition boundaries 1-3 may shift when the data is actually written on the disk. The transition shift of boundaries 1-3 are shown by arrows 301 in diagram 300, which results in the shift of the transitions of diagram 310. The arrows 301 indicate a condition in which charges from a previous transition (or transitions) tend to pull the next transition closer to it, as the data is written. Thus, for example, in diagram 300, transition boundary 2 is pulled toward transition 1 and transition boundary 3 is pulled toward transition 2. The amount of shift of each transition is dependent on a number of factors, including frequency. Generally, a greater pull is exerted when transitions are closer together. Therefore, due to the transition shift during the writing of data on the disk, the location of the transition may be distorted and the amount of the non-linear transition shift for each bit is generally data dependent.

As illustrated in diagram 310, transition boundaries 1-3 have shifted and the spacing between transitions 2 and 3 is now noticeably reduced. The effects of transition shifts are generally known and the amount of the transition shift is dependent on the transition spacing, which is data dependent. The embodiments of the invention described below attempt to remove or reduce the transition distortion by providing a compensation scheme that adjusts the transition edge of the particular bit being written. The compensation scheme would attempt to prevent the transition shift noted between diagram 300 and diagram 310 when the data is written.

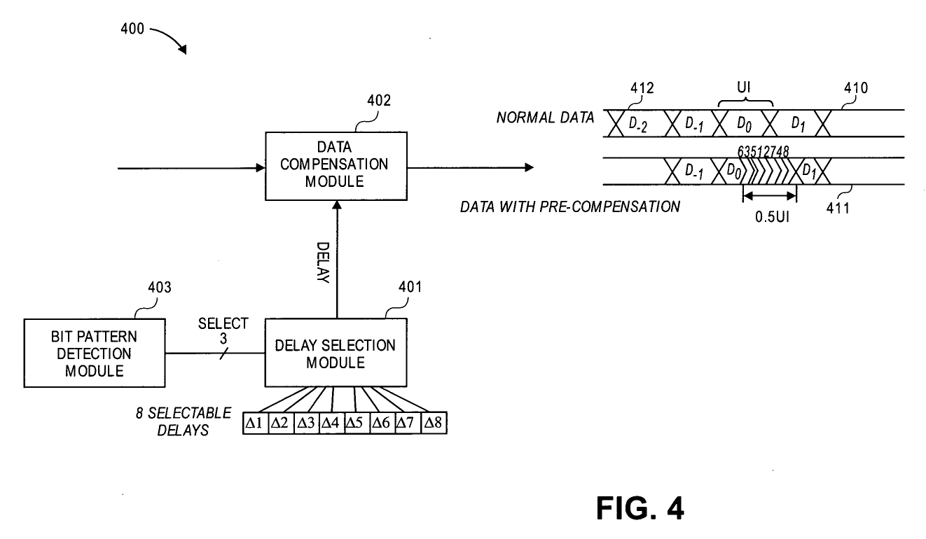

It is to be noted that a variety of techniques may be implemented to compensate the data written to the disk in order to maintain the intended transitions and prevent (or at least reduce) the amount of the transition shifts. FIG. 4 shows one embodiment for providing the compensation by adjusting the bit period when a particular bit is written to the disk. The compensation entails adjusting the leading edge of the bit earlier or later, in which the amount of the adjustment is dependent on the data pattern sequence.

FIG. 4 shows a circuit 400 that includes a delay selection module 401, a data compensation module 402 and a bit pattern detection module 403. Data that is to be written to the disk is coupled as input to compensation module 402. Timing of the input data is shown in data diagram 410, in which D₋₂, D₋₁, D₀ and D₁ exemplify three data bits in sequence that is being written. It is to be noted that the bit period, defined as unit interval (UI), is fixed with the input data. In the prior art, this is the data that is written to the disk and, therefore, may result in the non-linear transition distortions. Diagram 411 exemplifies what happens to the data when module 402 provides the write pre-compensation to the data bits to adjust the duration of the bit period. In particular, the compensation provided by compensation module 402 is shown as applied to bit D₀ in diagram 411.

Bit pattern detection module 403 is utilized to detect a particular bit pattern that is to be written. The bit pattern detection is applied to a certain grouping of bits, which may be a pre-selected number of bits in a string, bits in a symbol, or some other apportionment of bits. Bit pattern detector looks at the state of the various bits in the particular grouping and generates a delay select signal corresponding to a particular bit pattern detected. Generally, a certain number of previous bits are looked at for detection of a pattern. For example, one embodiment may look at the previous three bits. However, the pattern may be expanded much larger, such as looking at the previous five to ten bits. The pattern is not limited to any size.

Delay selection module 401 receives the delay select signal from bit pattern detection module 403 and selects a pre-defined delay, based on the delay selection signal. In one particular embodiment, bit pattern detection module 403 looks at three previous bits and generates a three-bit delay select signal to delay selection module 401 to select one of eight delays (Δ1-Δ8), which is then coupled as a delay signal to compensation module 402. Furthermore, in one embodiment, delay selection module 401 is comprised of a look-up table, wherein the three-bit delay select signal selects one of eight entries in the table to select a pre-defined delay. In some embodiments, the entries of the look-up table are programmable, so that delay values may be programmed. The entries, whether from a look-up table or some other means, may provide coefficient values that are used to process various delay times to generate the delay coupled to data compensation module 402.

It is to be noted that a variety of techniques may be implemented in bit pattern detection module 403 to determine what amount of delay is appropriate for a particular bit pattern under detection. As noted above, delays may be generated using a variety of techniques, including the use of coefficient values, which may then be used to adjust a phase of a reference clock signal in delay selection module 401 to generate the delays. Likewise, the selection of the number of available delays and the number of bits used for the delay selection may vary from embodiment to embodiment. In some instances, functions of modules 403 and 401 may be combined in one module, or both functions combined within compensation module 402. Alternatively, bit pattern detection may be performed elsewhere, in which the delay selection signal is sent to delay selection module 401. Also, other means of determining a delay may be implemented by delay selection module 401 and need not be limited to a look-up table.

As noted in diagram 411 with regard to bit D₀, one of eight delay values is used to adjust the timing of a period for bit D₀ and the start of the next bit D₁. It is to be noted that the term delay is used in the description to identify a delay period between a reference clock signal and a delayed clocked signal generated in delay selection module 401. The actual delay may increase or decrease the bit duration time of a bit from the fixed UI of the incoming bit, and in some instance, the resulting bit duration may equal the original UI. As shown in diagram 411, the delay values Δ1-Δ8 are used to shift the starting transition point of the timing for bit D₁ from the original start of D₁. The actual amount of the transition that may be applied varies from disk to disk, but in one embodiment, the transition variation is set to approximately 0.5 UI, as shown in diagram 411. That is, the end transition of D₀ and beginning of D₁ varies by approximately 50% from the original fixed position.

In one embodiment, the transition is set approximately between −0.15 UI and +0.35 UI from the end of the original transition, so that the original D₀ period of 1.0 UI is adjusted in the approximately range 0.85 UI-1.35 UI. As noted, the delay granularity is eight so that one of eight delay values is selected in the approximately range −0.15 UI and +0.35 UI for the end transition of the D₀ period and start of the D₁ period. It is to be noted that the granularity may be increased if additional delay values are made available for selection in the delay selection module 401. Similarly, the range for the bit transition may be set to other than 0.5 UI. Furthermore, in the description above, delay is used to adjust the end of the bit transition period and the start of the next bit period, however, in other embodiments, other measuring criteria may be applicable. The ultimate result to be obtained is to adjust the duration of the period in accordance with a bit pattern (such as looking at the previous “x” number of bits) to reduce the non-linear effects that cause transition distortion.

It is to be noted that different data patterns create different scenarios which may further create different amount of transitions. In the above described embodiment, the various possible scenarios are categorized into eight selectable delays that are chosen real time according to the current data pattern. In other embodiments, more or fewer delays may be employed. Further, FIG. 4 shows an example of applying the delay to bit D₀, but it is understood that the delay value may be applied to each bit that is to be written. With reference to FIGS. 1 and 2, in one embodiment, circuit 400 of FIG. 4 may be implemented in the read/write channel 201 of the disk controller 210. In other embodiments, circuit 400 may be implemented in the write path, but elsewhere in the controller.

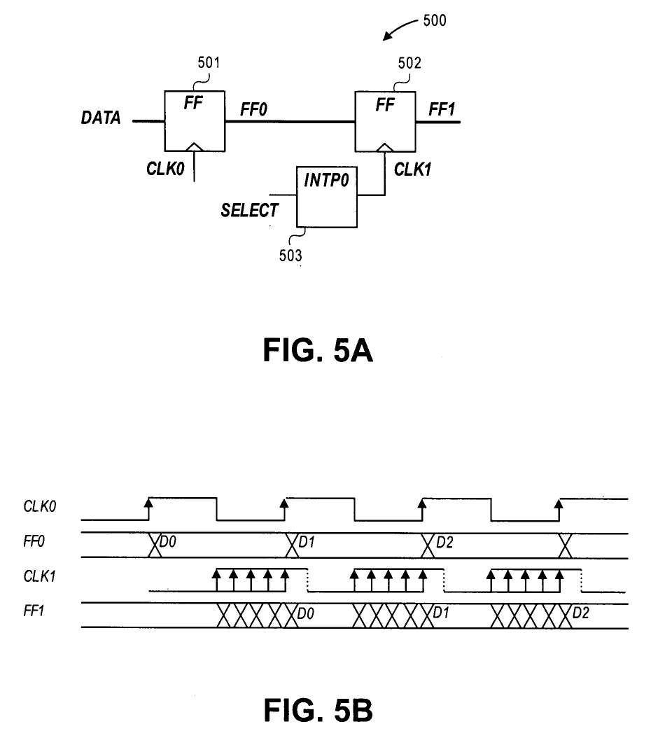

The above description identifies the concept of generating variable delays to adjust the UI for each bit to adjust the start of the next bit period. Variety of techniques may be implemented to achieve the varying of the data bit transition. FIG. 5A shows one embodiment of a circuit for implementing the variable bit transition. FIG. 5B is an accompanying timing diagram of various signals noted in FIG. 5A. In FIG. 5A, a circuit 500 is shown comprised of flip-flops (FF) 501, 502 and interpolator 503. The data to be written is input to FF 501 and triggered by a clock signal CLK0 to generate output FF0. The FF0 output in relation to CLK0 is shown in FIG. 5B. Next, a clock signal CLK1 with controllable phase is used to trigger FF1, so that data transitions through FF 502 to generate output FF1. Interpolator 503 provides the desired delay by generating CLK1, in which CLK1 has a delay from CLK0 to output FF1. Note that in this context, the delay is regarded as the delay time between the rising edge of CLK0 and the rising edge of CLK1. That is, the delay value introduced by interpolator 503, causes CLK1 to latch output FF0 as output FF1 with the selected delay.

As noted, in one embodiment, the delay value causes bit period of FF1 output to provide a edge transition variation in the approximate range of 0.85-1.35 (85%-135%) UI of the respective original bit period of 1.0 UI. Also, although flip-flops are shown in FIG. 5A, as well as in subsequent Figures, it is understood that various latches, other latching circuits, as well as other components, may be used to clock in the data bits. Similarly other devices and circuits may be used for the interpolators described herein that provide the bit transition delay.

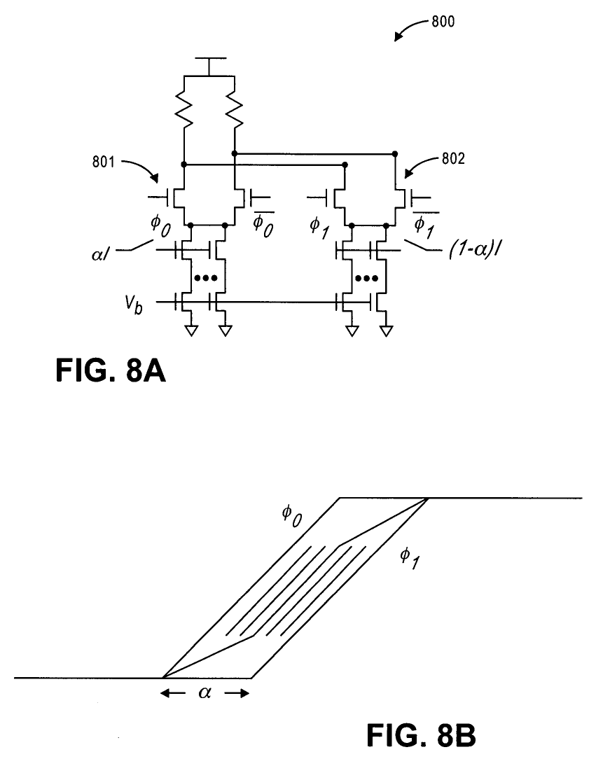

It is to be noted that in reference to FIG. 4, delay selection module 401 comprises interpolator 503 and data compensation module 402 comprises FFs 501, 502. The delay value establishes the timing between reference clock signal CLK0 and the delayed clock signal CLK1. CLK0 clocks FF 501 and CLK2 clocks FF 502. A variety of interpolators may be utilized for interpolator 503. One such example of a phase interpolator is to add two different phases at different weightings. A phase interpolator 800 of FIG. 8A generates a fine phase output between phases φ₀ and φ₁, by adding the current I from two differential pairs 801, 802 at different ratio α [e.g. and αI and (1−α)I]. A graphical representation of the phase variation between φ₀ and φ₁ based on a is shown in FIG. 8B.

To generate a wider range of output phases, φ₀ and φ₁ may be separated further apart, or more input clock phases may be added. The former method encounters a limitation on how far φ₀ and φ₁ may be separated and may depend on the slew rate. The latter method is capable of a wide range of the output phase.

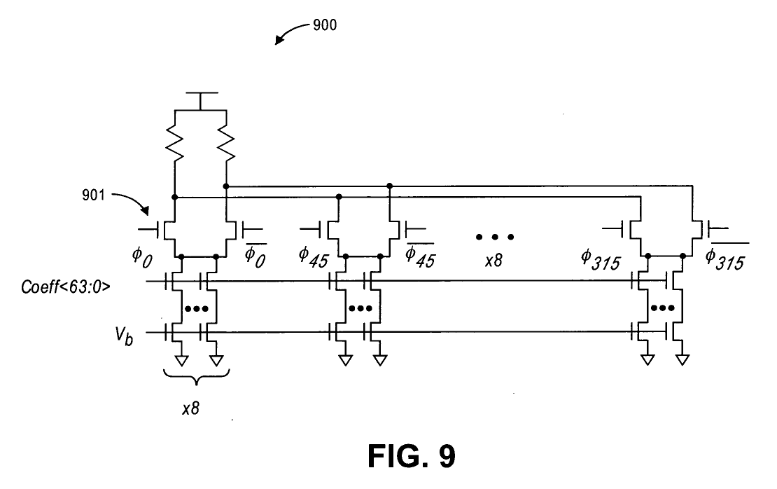

Thus, another example of a phase interpolator is shown in FIG. 9. Phase interpolator 900 uses eight equally spaced phases. For example, phase separation may be approximately set as 0°, 45°, 90°, 135°, 180°, 225°, 270° and 315° for each differential pair. Note that eight differential pairs 901 are shown in FIG. 9 with bias by bias voltage Vb to obtain the eight phase values. Interpolator 900 allows the tail current to be divided into eight smaller currents. With the eight phases and eight divisions per phase, interpolator 810 has a resolution of 1/64 or 1.6% UI over the whole one UI cycle. The control bits (shown as Coeff<63:0>) form a 64-bit control signal to control turn on of the differential pairs 901. In other embodiments, 40 bits are used. In other embodiment, less or more number of bits may be used. It is to be noted that the interpolators shown in FIGS. 8 and 9 are just two examples. Other interpolator designs may be used in other embodiments.

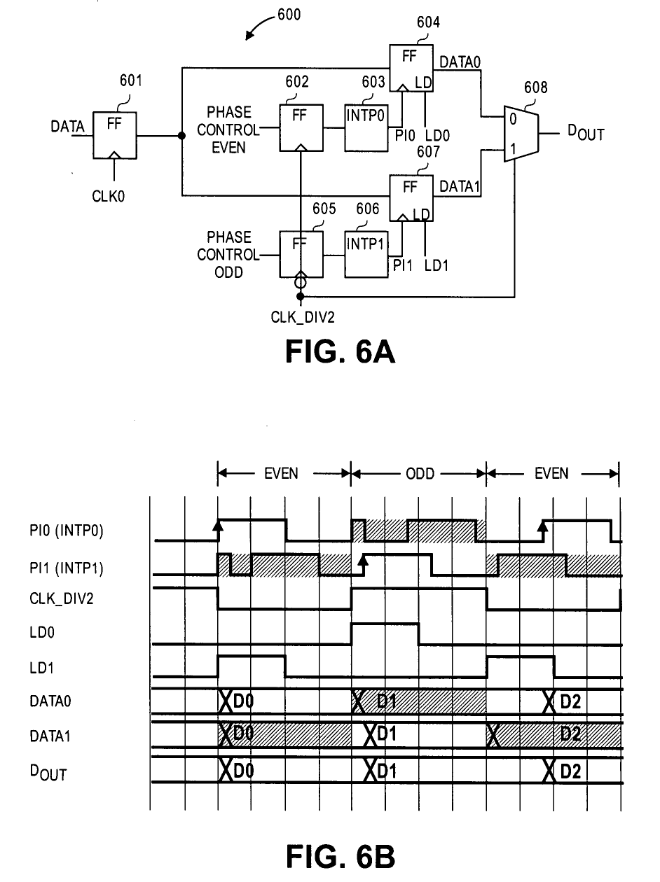

Although the circuit of FIG. 5A is operable to generate output FF1 so that data transitions at the desired time to provide compensation for the data being written to a disk, it may be difficult to generate this clock waveform, because the falling edge of CLK1 is not well defined. It may also be difficult to maximize the timing margin of the proceeding logic since the falling edge should be dynamically placed approximately at the middle of the two rising edges for better performance. Accordingly, in order to relax the difficulty of generating CLK1, one embodiment uses two interpolators to generate even and odd clock edges, as shown in FIG. 6A.

In FIG. 6A, a circuit 600 is shown in which two interpolators are utilized. FIG. 6B is an accompanying timing diagram of various signals noted in FIG. 6A. Circuit 600 is equivalent to circuit 500 for providing the delay for write pre-compensation, but circuit 600 uses two interpolators, noted as phase interpolators 603 (INTP0) and 606 (INTP1). Interpolators 603 and 606 operate as even and odd interpolators, wherein each respective interpolator interchanges each cycle. While one interpolator is providing a clean clock signal, the other interpolator changes the output phase that will be used in the next cycle. A multiplexer (mux) 608 selects between the outputs of flip-flops clocked by the two interpolators 603, 606, wherein any glitch effects that may be caused by an interpolator during a phase change is prevented from coupling through to the output of the mux 608.

Circuit 600 includes an input FF 601 for latching in the data to be written to the disk. FF 501 is clocked by CLK0 and operates equivalently to FF 501 of FIG. 5A. The output of FF 601 is split and coupled to FF 604 on the even phase side and to FF 607 on the odd phase side. FF 604 and FF 607 operate equivalently to FF 502 of FIG. 3, except that each FF is used during the respective even/odd phase portion. Interpolator 603 has a phase output PI0, which clocks FF 604, similar to interpolator 503 clocking FF 502 in FIG. 5, but during the even phase. Similarly, interpolator 606 has a phase output PI1, which clocks FF 607 during the odd phase. Output DATA0 of FF 604 and output DATA1 of FF 607 are coupled to mux 608 and either DATA0 or DATA1 is selected as output D_{OUT} from mux 608, depending on the phase.

An even phase control signal is coupled to interpolator 603 through FF 602. Similarly, an odd phase control signal is coupled to interpolator 606 through FF 605. The two phase control signals are used to select a delay in their respective interpolators 603, 606. A divide-by-two clock signal (CLK_DIV2) is used to alternatively clock FF 602, 605, depending on the even/odd phase. The CLK_DIV2 signal is also used as a mux select signal to select even/odd output from mux 608.

In operation, at even bits, interpolator 603 provides the desired edge to clock FF 604. During this bit time, a divide-by-two clock signal (CLK_DIV2) is low, the phase control stored in FF602 command interpolator 603 to provide the desired delay. The rising edge of PI0 triggers FF 604 to output DATA0 from the even phase side of circuit 600. The low state of CLK_DIV2 causes DATA0 to be output from mux 608. During this even bit period, data is latched through FF 604, based on a delay selected by interpolator 603. The compensated DATA0 is output as D_{OUT}. As noted in the diagram of FIG. 6B, FF 605 is updated at the falling edge of CLK_DIV2, which may cause interpolator output INTP1 to have a glitch, which may affect output DATA1. However, since DATA1 is not selected by mux 608 during the even bit period, the glitch is not coupled through mux 608.

At odd bits, the process is just the opposite, in that the phase control stored in FF 605, which was changed from the previous cycle, specifies the value of interpolator 606. Interpolator 606 is stable and the odd phase delay value is coupled to operate the delay timing in FF 607. During this odd bit period, CLK_DIV2 selects DATA1 as the output from mux 608. The two interpolators 603, 606 continue to interchange eve/odd bit times to provide accurate phase delay for each respective side. As noted in FIG. 6B, although all data bits are coupled to both the even and odd sides of circuit 600, even bits (D0, D2, D4 . . . ) are obtained from DATA0 as output D_{OUT}, while odd bits (D1, D3, D5 . . . ) are obtained from DATA1. FIG. 6B also shows a hashed portion that identifies signals that are not desirable for reliable control and/or output during a give even/odd bit period. Thus, during an even bit period, PI1 and DATA1 are not reliable and, therefore, not relied upon to produce the output D_{OUT}. During an odd bit period, PI0 and DATA0 are not reliable and not relied upon to produce D_{OUT}.

It is to be noted that during the phase change period for the interpolators, (hashed area of PI0 and PI1), the output of the interpolators may not contain any rising edge in some instances. Without the rising edge, DATA0 and DATA1 do not update, which may cause an old bit value to be output when the mux selection flips. To ensure that the data is updated into FF 604, 607, data may be forced to be loaded into FF 604, 607 when the corresponding interpolator is to change state. In one particular embodiment, respective load signals LD0 and LD1 are used to load the data into FF 604, 607, when LD0 and LD1 go high. In one embodiment, LD0 and LD1 signals may be obtained by taking an AND function between quadrature clocks from CLK_DIV2.

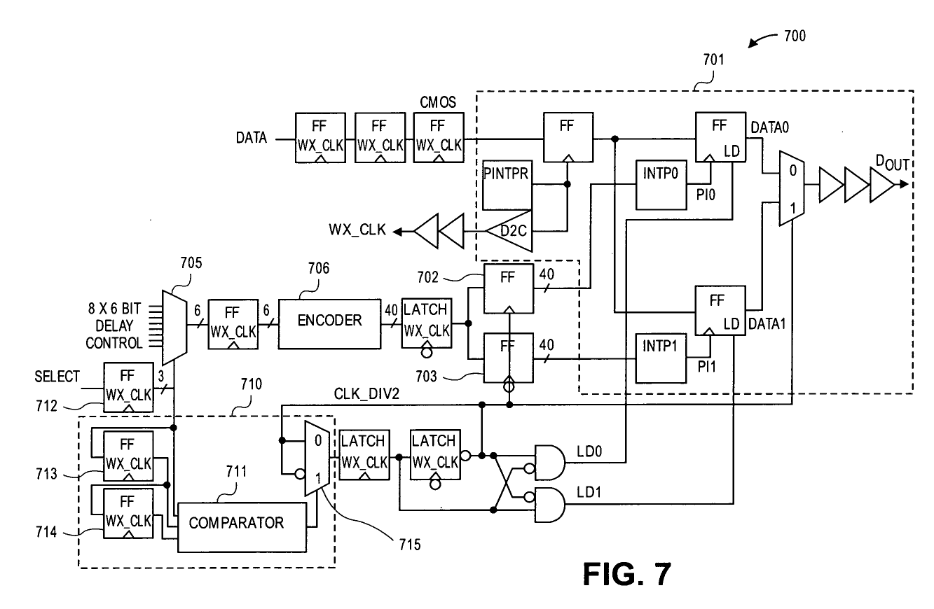

FIG. 7 shows a more detailed circuit 700, which incorporates circuit 600 of FIG. 6A. Portion of circuit 700 enclosed within box 701, along with FFs 702, 703, are equivalent to circuit 600 of FIG. 6A. Circuitry which generates the phase control even/odd signals to FFs 702, 703 is also shown. In this embodiment, circuit 700 is capable of providing eight different changeable delays in real-time, with each delay tuned by a step of approximately 1.6% UI. The SELECT signal to FF 712 selects one of eight delay control signals at mux 705. Each delay control signal is 6-bits in this particular example embodiment. Each 6-bit word specifies a corresponding delay for the phase interpolator which sets the timing of PI0 or PI1. The 6-bit word spends one cycle to convert to a 64-bit code in encoder 706, in which 40 out of the 64 bits are output from encoder 706, and the rest are set to 0 because the phase range of only 0.5 UI is needed. In one embodiment, the 40 bits correspond to 32 zeros and 8 ones, to provide 33 phase transitions (0-32) to move the bit transition 0.5 UI. This 40-bit encoded signal is then coupled to the two interpolators of circuit 700. Interpolator 900 of FIG. 9 is one example of an interpolator that may be used for interpolator INTP0 and INTP1 of FIG. 7.

Furthermore, circuit 700 also uses three FFs at the data input to delay the data through three stages of FFs to match the delay of the 6-bit word used for determining the interpolator delays. Also, in one embodiment, the FFs clocked by the interpolators are current mode logic (CML) devices. In circuit 700, the divide-by-two clock signal CLK_DIV2 is also used to generate the LD0 and LD1 signals.

In some instances, there may be mismatch between the two interpolators, which may cause transition dithering even though delay control settings remain substantially constant. To reduce the dithering during quiescent conditions, a portion of circuit 700 that resides within box 710 is employed. This portion of the circuitry uses a comparator 711 to compare the outputs of the FFs to freeze the CLK_DIV2 when delay control settings do not change. Output from comparator 711 controls mux 715 which sets the timing for generation of CLK_DIV2, LD0 and LD1. When outputs of FFs 712, 713, 714 are all equal, comparator 711 generates a “1” output and when not all equal, generates a “0” output.

It is to be noted that various other circuitry may be implemented to introduce varying bit transition times to pre-compensate data that is being written to a disk. Application of selected delay times to adjust the transition edge of the start of the next bit is but one technique to adjust the bit transition timing. Furthermore, the described pre-compensation technique need not be limited to magnetic disk drives. Most any systematic transition variations may be compensated by use of the invention. Also, the described pre-compensation is performed in the digital domain, but the technique may be readily performed in the analog domain, such as by using an analog delay line.

Thus, architecture for write pre-compensation is described.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled” and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items.

Furthermore, the term “module” is used herein to describe a functional block and may represent hardware, software, firmware, etc., without limitation to its structure. A “module” may be a circuit, integrated circuit chip or chips, assembly or other component configurations. Accordingly, a “processing module” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions and such processing device may have accompanying memory. A “module” may also be software or software operating in conjunction with hardware.

The embodiments of the present invention have been described above with the aid of functional building blocks illustrating the performance of certain functions. The boundaries of these functional building blocks have been arbitrarily defined for convenience of description. Alternate boundaries could be defined as long as the certain functions are appropriately performed. Similarly, flow diagram blocks and methods of practicing the embodiments of the invention may also have been arbitrarily defined herein to illustrate certain significant functionality. To the extent used, the flow diagram block boundaries and methods could have been defined otherwise and still perform the certain significant functionality. Such alternate definitions of functional building blocks, flow diagram blocks and methods are thus within the scope and spirit of the claimed embodiments of the invention. One of ordinary skill in the art may also recognize that the functional building blocks, and other illustrative blocks, modules and components herein, may be implemented as illustrated or by discrete components, application specific integrated circuits, processors executing appropriate software and the like or any combination thereof.

I claim:

1. An apparatus comprising:
a delay selection module coupled to receive a select signal to select a delay value by phase interpolation, corresponding to a bit pattern of data which is to be compensated; and
a data compensation module coupled to receive the selected delay value from the delay selection module and to adjust bit transition of a particular bit of the data by phase interpolation, based on the selected delay value to compensate for a non-linear effect that causes transition distortion.

2. The apparatus of claim 1, wherein the data compensation module is to receive the data, in which each bit of the data has a fixed bit transition period, and the data compensation module to adjust an edge of the fixed bit transition period for the particular bit based on the delay value to obtain a delay adjusted bit transition period.

3. The apparatus of claim 2, wherein the data compression module is to provide the delay adjusted bit transition period that is approximately between 0.85 and 1.35 of a duration of the fixed bit transition period.

4. The apparatus of claim 2, wherein the delay selection module includes an interpolator to receive the select signal and to generate a second clock signal which is delayed from a first clock signal based on the delay value, and wherein the second clock signal is used to clock the particular bit through the data compensation module with the delay adjusted bit transition period.

5. The apparatus of claim 4, wherein the delay selection module includes two interpolators in which one interpolator provides delay values for odd data bits and a second interpolator provides delay values for even data bits.

6. The apparatus of claim 4, wherein the data compensation module provides bit compensation for each bit of the data to adjust for the non-linear effect in writing the data bits to a magnetic disk.

7. The apparatus of claim 4, wherein the data compensation module provides write pre-compensation for each bit of the data that is to be written to a storage medium to compensate for transition distortion of the bits when the bits are written onto the storage medium.

8. The apparatus of claim 1 further including a bit pattern detection module coupled to detect the bit pattern of the data and to generate the select signal based on the bit pattern for the particular bit.

9. An apparatus comprising:
an interpolator coupled to receive a select signal to select a delay value by phase interpolation, corresponding to a bit pattern of data which is to be compensated; and
a latching circuit coupled to receive the selected delay value from the interpolator and to adjust bit transition of a particular bit of the data, based on the selected delay value to compensate for a non-linear effect that causes transition distortion.

10. The apparatus of claim 9, wherein the latching circuit is to receive the data, in which each bit of the data has a fixed bit transition period, and the latching circuit to adjust an edge of the fixed bit transition period for the particular bit based on the delay value to obtain a delay adjusted bit transition period.

11. The apparatus of claim 10, wherein the latching circuit is to provide the delay adjusted bit transition period that is approximately between 0.85 and 1.35 of a duration of the fixed bit transition period.

12. The apparatus of claim 10, wherein the interpolator is to receive the select signal and to generate a second clock signal which is delayed from a first clock signal based on the delay value, and wherein the second clock signal is used to clock the particular bit through the latching circuit with the delay adjusted bit transition period.

13. The apparatus of claim 12, wherein the interpolator includes at least two interpolators in which one interpolator provides delay values for odd data bits and a second interpolator provides delay values for even data bits.

14. The apparatus of claim 12, wherein the latching circuit provides bit compensation for each bit of the data to adjust for the non-linear effect in writing the data bits to a magnetic disk.

15. The apparatus of claim 12, wherein the latching circuit provides write pre-compensation for each bit of the data that is to be written to a storage medium to compensate for transition distortion of the bits when the bits are written onto the storage medium.

16. A method comprising:
selecting a delay value by phase interpolation, corresponding to a bit pattern of data which is to be compensated based on a received select signal; and
adjusting a bit transition of a particular bit of the data based on the selected delay value to compensate for a non-linear effect that causes transition distortion.

17. The method of claim 16, wherein adjusting the bit transition includes adjusting an edge of a fixed bit transition period for a particular bit based on the delay value to obtain a delay adjusted bit transition period.

18. The method of claim 17, further including writing the particular bit with the delay adjusted bit transition period to a storage medium to compensate for the transition distortion.

19. The method of claim 17, further including writing the particular bit with the delay adjusted bit transition period to a magnetic disk to compensate for the transition distortion.

20. The method of claim 16 further including detecting the bit pattern of the data and generating the select signal based on the bit pattern.
